(19) United States
(12) Patent Application Publication
(10) Pub. No.: US 2009/0084482 A1
(43) Pub. Date: Apr. 2, 2009

(54) Pneumatic tire having built-In sealant layer and preparation thereof

(76) Inventors: Ramendra Nath Majumdar, Hudson, OH (US); Aaron Scott Puhala, Kent, OH (US)

Correspondence Address: WOOD, HERRON & EVANS, LLP, 2700 CAREW TOWER, 441 VINE STREET, CINCINNATI, OH, 45202, US

(21) Appl. No.: 11/863,994

(22) Filed: Sep. 28, 2007

(51) Int. Cl. B60C 19/12; B29D 30/06

(52) U.S. Cl. 152/504; 156/115

(57) ABSTRACT

A pneumatic tire is provided which includes an outer circumferential rubber tread and a supporting carcass. A rubber inner liner is disposed inwardly from the supporting carcass. A built-in sealant layer is situated adjacent to an innermost removable barrier layer and disposed inwardly from the rubber inner liner. The built-in sealant layer provides self-sealing properties to the pneumatic tire. The pneumatic tire, with its innermost removable barrier layer, keeps the sealant layer from sticking to a tire-building apparatus during tire assembly and, after curing of the assembled tire, is eventually removed to permit gas from the built-in sealant layer to become part of the tire's inflation air to prevent or reduce instances of inner liner blister formation.

### FIELD OF THE INVENTION

The present invention is directed to a pneumatic tire having a built-in sealant layer and its preparation.

### BACKGROUND OF THE INVENTION

Various methods, sealants and tire constructions have been suggested for pneumatic tires that relate to use of liquid sealant coatings in which the sealant flows into the puncture hole. However, such liquid sealants can flow excessively at elevated temperatures and cause the tire to become out of balance. Also, the liquid sealant may not be entirely operable or effective over a wide temperature range extending from summer to winter conditions. More complicated tire structures which encase a liquid sealant in a vulcanized rubber material can be expensive to manufacture and can also create balance and suspension problems due to the additional weight required in the tire.

Puncture sealing tires also have been further proposed wherein a sealant layer of degradable rubber is assembled into an unvulcanized tire to provide a built-in sealant. The method of construction, however, is generally only reasonably possible when, for example, the sealant layer is laminated with another non-degraded layer of rubber, e.g., a tire inner liner, which permits handling during the tire building procedure. This is because the degradable rubber tends to be tacky or sticky in nature and lacks strength making it very difficult to handle alone without additional support. The inner liner also keeps the sealant layer from sticking to a tire-building apparatus. By laminating the sealant layer between two or more non-degraded rubber layers, e.g., the tire inner liner and a tire carcass, the sealant layer retains structural integrity during the vulcanization operation wherein high pressures are applied to the tire, which would otherwise displace the degraded rubber layer from its desired location. Accordingly, the resulting puncture sealing tire typically has a sealant layer between the inner liner and tire carcass.

Such a lamination procedure significantly increases the cost of manufacturing a tire. In addition, the compounds in the built-in sealant, e.g., organic peroxide depolymerized butyl rubber, may generate gases at higher temperature, such as during cure or during tire use, which can result in aesthetically unappealing inner liner blister formation. Aside from being unappealing, such blister formation may allow the sealant to unfavorably migrate away from its intended location. To combat blister formation, the inner liner, for example, can be provided at an increased thickness but this can add to the cost of building a tire.

Accordingly, there is a need for a simple and practical method of preparing a self-sealing tire that eliminates or reduces blister formation in the tire inner liner.

### SUMMARY OF THE INVENTION

The present invention is directed to a pneumatic tire having a built-in sealant layer and the method of manufacturing such a tire.

In one embodiment, a pneumatic tire includes an outer circumferential rubber tread and a supporting carcass. A rubber inner liner is disposed inwardly from the supporting carcass. A built-in sealant layer is situated adjacent to an innermost removable barrier layer. The sealant layer provides self-sealing properties to the pneumatic tire. The tire, with its innermost removable barrier layer, keeps the precursor sealant layer from sticking to a tire-building apparatus and, after curing of an assembled tire, is removed to permit gas from the built-in sealant layer to become part of the tire's inflation air, such as when the tire is at its running temperature, to prevent or reduce instances of inner liner blister formation.

The pneumatic tire, in one embodiment, can be prepared by positioning a removable barrier layer on a tire-building apparatus. Next, a precursor sealant layer is positioned directly on the removable barrier layer. A rubber inner liner is disposed outwardly of the precursor sealant layer followed by a tire carcass then a rubber tire tread on the tire carcass to define an unvulcanized tire assembly. The unvulcanized tire assembly can be vulcanized under conditions of heat and pressure such that the precursor sealant layer provides the pneumatic tire with a built-in sealant layer with self-sealing properties. Then, the removable barrier layer is eventually removed from the pneumatic tire, after curing thereof, to expose the built-in sealant layer.

In another embodiment, a method of preparing a pneumatic tire includes positioning a thermoformable film of polymeric material on a tire-building apparatus. Next, a precursor sealant layer is positioned directly on the thermoformable film. The precursor sealant layer can include an uncured butyl rubber-based rubber composition or a polyurethane based composition. A rubber inner liner is positioned directly on the precursor sealant layer followed by a tire carcass then a rubber tire tread on the tire carcass to define an unvulcanized tire assembly. The precursor sealant layer provides the pneumatic tire with a built-in sealant layer with self-sealing properties after vulcanization. To that end, the unvulcanized tire assembly can be vulcanized under conditions of heat and pressure such that the precursor sealant layer provides the pneumatic tire with the built-in sealant layer with self-sealing properties. Then, the removable barrier layer can be removed from the pneumatic tire, after curing thereof, to expose the sealant layer.

By virtue of the foregoing, there is provided a pneumatic tire that has an ability to seal against various puncturing objects and can eliminate or reduce inner liner blister formation in the tire, for example.

### BRIEF DESCRIPTION OF THE DRAWINGS

The accompanying drawings, which are incorporated in and constitute a part of this specification, illustrate embodiments of the invention and, together with the general description of the invention given above, and detailed description given below, serve to explain the invention.

FIG. 1 is a cross-sectional view of a pneumatic tire in accordance with one embodiment of the present invention; and

FIG. 2 is a cross-sectional view partially broken away of an unvulcanized tire assembly prepared in accordance with one embodiment of the present invention; and

FIG. 3 is a perspective view of the pneumatic tire shown in FIG. 1 with a removable barrier layer being removed from the rubber inner liner of the tire.

### DETAILED DESCRIPTION

FIG. 1 shows a pneumatic tire 10 that has an ability to seal against various puncturing objects and has the ability to eliminate or reduce blister formation in the tire 10, particularly inner liner blister formation. The tire 10 includes sidewalls 12, an outer circumferential rubber tread (or tread portion) 14, a supporting carcass 16, inextensible beads 18, a rubber inner liner (or air barrier layer) 20, a built-in sealant layer 22, and an innermost removable barrier layer 24. The individual sidewalls 12 extend radially inward from the axial outer edges of the tread portion 14 to join the respective inextensible beads 18. The supporting carcass 16 acts as a supporting structure for the tread portion 14 and sidewalls 12. The rubber inner liner 20 is disposed inwardly from the supporting carcass 16. The sealant layer 22 is adjacent the innermost removable barrier layer 24 and disposed inwardly from the rubber inner liner 20. The outer circumferential tread 14 is adapted to be ground contacting when the tire 10 is in use.

The built-in sealant layer 22, prior to vulcanization of the pneumatic tire 10, is referred to herein as a precursor sealant layer 23. The precursor sealant layer 23 can generally include any non-flowing sealant material known in the art, and is discussed below.

The innermost removable barrier layer 24 of the tire 10 defines a thermoformable film of polymeric material. Such thermoformable film is conforming, has essentially no memory, and is non-elastomeric. Furthermore, the barrier layer 24 must not melt at cure temperatures. In one example, the barrier layer 24 includes a thermoformable film of nylon or blend of nylon and rubber. Examples of nylons which may be formed into film are linear polycondensates of lactams of 6 to 12 carbon atoms and conventional polycondensates of diamines and dicarboxylic acids, e.g. nylon 6,6; nylon 6,8; nylon 6,9; nylon 6,10; nylon 6,12; nylon 8,8 and nylon 12,12. Further examples include nylon 6, nylon 11 and nylon 12, which are manufactured from the corresponding lactams. Suitable nylon thermoformable films include Dartek™ films available from DuPont of Wilmington, Del. In addition, the polymeric material of the thermoformable films may include polycondensates of aromatic dicarboxylic acids, e.g., isophthalic acid or terephthalic acid, with diamines, e.g., hexamethylenediamine, or octamethylenediamine, polycarbonates of aliphatic starting materials, e.g., m- and p-xylylenediamines, with adipic acid, suberic acid and sebacic acid, and polycondensates based on alicyclic starting materials, e.g. cyclohexanedicarboxylic acid, cyclohexanediacetic acid, 4,4′-diaminodicyclohexylmethane and 4,4′-diaminodicyclohexylpropane. The rubber used in the blend may include a natural and/or synthetic rubber. In one example, the rubber includes butyl rubber, styrene butadiene rubber, and/or natural rubber.

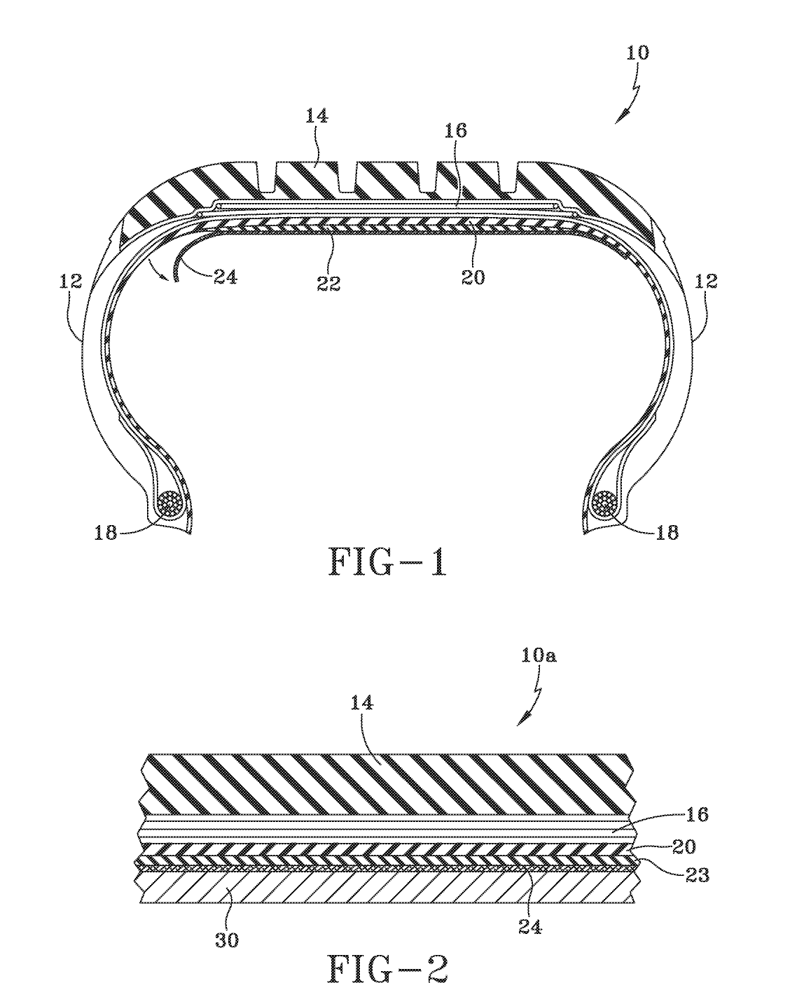

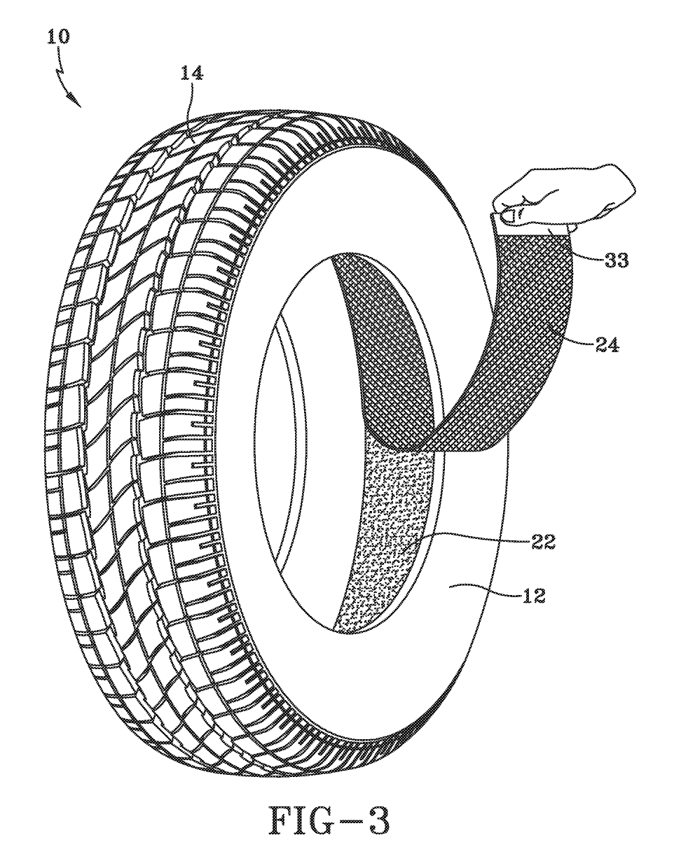

As further discussed below, the barrier layer 24 keeps the precursor sealant layer 23 from sticking to a tire-building apparatus 30 and, after curing of an assembled tire 10a (See FIG. 2), can be removed to permit gas from the resulting built-in sealant layer 22 to escape thus eliminating or reducing inner liner blister formation. Removal of the barrier layer 24 also helps the sealant layer 22 to flow and thereby seal resulting punctures that the tire 10 may encounter. The barrier layer 24, which is substantially inextensible at ambient temperature, is removable without tearing into pieces from the protected surface of the tire 10. To be manually readily removable, the barrier layer 24 does not fuse to itself when overlapped and heated to tire cure temperature. One end of the barrier layer 24 may be overlapped over the other (which other end is adjacent the precursor sealant layer 23) so as to form a pull-tab 33 (See FIG. 3) for easy removal from the resulting built-in sealant layer 22. Also, to facilitate visual detection, the pull-tab 33 may be colored.

With respect to the precursor sealant layer 23, the precursor sealant layer 23 can generally include any non-flowing sealant material known in the art.

In one embodiment, the precursor sealant layer 23 can include a self-healing polyurethane composition. In one example, such polyurethane composition may define a non-flowing, or non-liquid, polyurethane composition that is neither gel-like nor substantially tacky and that provides a self-supporting precursor sealant layer 23. Concerning self-supporting, the polyurethane composition of the precursor sealant layer 23 maintains its own form, e.g., as a sheet or layer, without the need to be laminated to one or more supporting structures. The polyurethane composition is substantially non-tacky in that a sheet of the polyurethane composition, for example, may contact another sheet yet be pulled apart with relative ease and still substantially maintain its original form. The non-flowing polyurethane composition can include a self-healing polyurethane elastomeric material, which may contain, for example, methylene diphenyl 4,4′-diisocyanate (MDI) and poly(alkylene oxide) glycol. Such suitable polyurethane composition for use as the precursor sealant layer 23 may be obtained from Novex of Wadsworth, Ohio. In another example, the self-healing polyurethane composition is gel-like and tacky. One such suitable polyurethane composition is Tyrlyner® available from VITA Industrial Inc. of Thomasville, Ga. It should be understood that formulations of urethane materials that can be used for the self-healing polyurethane composition may be readily produced by persons having ordinary skill in the art from known chemistry techniques in the production of urethanes.

After vulcanization, the polyurethane composition provides a gel-like and tacky polyurethane composition, such as by way of thermal degradation, which provides the pneumatic tire 10 with self-sealing properties and defines the built-in sealant layer 22.

In another example, the precursor sealant layer 23 can include an uncured butyl rubber-based rubber composition. One such suitable uncured butyl rubber-based rubber composition is disclosed in U.S. Pat. No. 6,962,181 which is expressly incorporated by reference herein in its entirety.

In one embodiment, the uncured butyl rubber-based rubber composition may include a peroxide and a dispersion therein of a particulate precured rubber selected from the resin-cured butyl rubber. In one example, based upon parts by weight per 100 parts by weight of said butyl rubber, the butyl rubber-based rubber composition can include a copolymer of isobutylene and isoprene, wherein the copolymer contains from about 0.5 units to about 5 units derived from isoprene, and correspondingly from about 95 weight percent to about 99.5 weight percent units derived from isobutylene. The butyl rubber that can be employed may typically have a number average molecular weight, for example, in the range of 200,000 to 500,000. Such butyl rubber and its preparation is well known to those having skill in such art.

The uncured butyl rubber composition further includes a sufficient amount of organoperoxide to cause the butyl rubber to partially depolymerize, usually in a range of from about 0.5 to about 10 phr of the active organoperoxide depending somewhat upon the time and temperature of the tire curing operation and the degree of depolymerization desired.

Various organoperoxides may be used such as those that become active (e.g. generate peroxide free radicals) at high temperatures, that is, above about 100° C. Such organoperoxides are referred to herein as active peroxides. Examples of such organoperoxides are, for example, tert-butyl perbenzoate and dialkyl peroxides with the same or different radicals, such as dialkylbenzene peroxides and alkyl pre-esters. In one example, the active organoperoxide will contain two peroxide groups. In another example, the peroxide groups are attached to a tertiary butyl group. The basic moiety on which the two peroxide groups are suspended can be aliphatic, cycloaliphatic, or aromatic radicals. Some representative examples of such active organoperoxides are, for example, 2,5-bis(t-butyl peroxy)-2,5-dimethyl hexane; 1,1-di-t-butyl peroxi-3,3,5-trimethyl cyclohexane; 2,5-dimethyl-2,5-di(t-butyl peroxy)hexyne-3; p-chlorobenzyl peroxide; 2,4-dichlorobenzyl peroxide; 2,2-bis-(t-butyl peroxi)-butane; di-t-butyl peroxide; benzyl peroxide; 2,5-bis(t-butyl peroxy)-2,5-dimethyl hexane, dicumyl peroxide; and 2,5-dimethyl-2,5-di(t-butyl peroxy)hexane. Other suitable organoperoxides may be found in P. R. Dluzneski, “Peroxide vulcanization of elastomers”, Rubber Chemistry and Technology, Vol. 74, 451 (2001), which is expressly incorporated by reference herein in its entirety.

The peroxide can be added to the uncured butyl rubber composition in pure form (100 percent active peroxide) or on an inert, free-flowing mineral carrier. Silicon oil is an inert mineral carrier often utilized for this purpose. Such carrier composition containing from about 35 weight percent to 60 weight percent active ingredient (peroxide) can be employed. For example, 40 percent by weight dicumylperoxide on an inert carrier can be employed as the peroxide vulcanizing agent in the butyl rubber composition layer.

The uncured butyl rubber-based rubber composition may further include particulate filler including about 5 phr to about 90 phr of at least one of rubber reinforcing carbon black and coal dust, or mixtures thereof, and, optionally from zero phr to 6 phr of short fibers, and/or from zero phr to about 20 phr of hollow glass microspheres. It is also to be understood that other known fillers and/or reinforcing agents, such as silica and calcium carbonate, can be substituted for part of the carbon black in this composition.

For the carbon black, various particulate rubber reinforcing carbon blacks are, for example, carbon black referenced in The Vanderbilt Rubber Handbook, 1978, Pages 408 through 417, which are characterized by iodine adsorption (ASTM D1510) and dibutylphthalate absorption (ASTM D 2414) values which are prepared by deposition from a vapor phase at very high temperatures as a result of thermal decomposition of hydrocarbons, rather than a carbonization of organic substances. Such carbon black may have an Iodine adsorption value ranging from 20 mg/g to 270 mg/g and a dibutylphthalate absorption value ranging from 60 cc/100 gms to 180 cc/100 gms. Such carbon black is composed of aggregates of elemental carbon particles of colloidal dimensions, which have a high surface area.

Coal dust, or coal fines, is carbonaceous dust from naturally occurring coal. Coal dust is of significantly greater size than rubber reinforcing carbon black, is not rubber reinforcing in the sense of rubber reinforcing carbon black, and represents a significantly lower cost filler than rubber reinforcing carbon black. The coal dust can be used in greater quantities (concentration) in the butyl rubber composition without significantly adversely affecting the processing of the composition, yet being beneficial to aid in the efficiency of the puncture sealing ability of the resultant built-in sealant layer 22. Further, the coal dust is considered herein useful in promoting adjustment of the storage modulus (G′) property of the sealant.

The short fibers may be selected from, for example, cotton fibers and from synthetic fibers selected from rayon, aramid, nylon and polyester fibers, or mixtures thereof. Such cotton short fibers may have an average length, for example, in a range of up to about 200 microns (e.g. an average length of about 150 microns) and the synthetic (e.g. the polyester and nylon fibers) may have an average length, for example, of up to a maximum of about 2,500 microns. The short fibers are considered herein to promote adjustment of a G′ property of the sealant composition as well as, in relatively low concentrations, not significantly interfering with the processing of the sealant precursor composition and enhancing the efficiency of the resultant built-in sealant layer 22 and its puncture sealing ability.

Representative of the hollow glass microspheres are, for example, Scotchlite Glass Bubbles™ (S60/10000 series), having an average spherical diameter of about 30 microns, from the 3M Company. The hollow glass microspheres are considered herein to promote adjustment of a G′ property of the sealant composition as well as enhancing the puncture sealing efficiency and capability of the built-in sealant and, in relatively low concentrations, not significantly adversely affecting the processing of the sealant precursor composition.

The uncured butyl rubber-based rubber composition may further include from zero phr to about 20 phr of rubber processing oil, such as one having a maximum aromatic content of about 15 weight percent with a naphthenic content in a range of from about 35 weight percent to about 45 weight percent and a paraffinic content in a range of about 45 weight percent to about 55 weight percent.

The various rubber processing oils are known to those having skill in such art. In one example, the rubber processing oil has a low aromaticity content, such as less than about 15 weight percent. Such a rubber processing oil may be composed of, for example, about 35 weight percent to about 45 weight percent naphthenic content, about 45 weight percent to about 55 weight percent paraffinic content, and an aromatic content of less than about 15 weight percent (e.g. from about 10 to about 14 weight percent). It is considered herein that a representative of such rubber processing oil is Flexon 641™ from the ExxonMobil company.

The uncured butyl rubber-based rubber composition may further include from zero phr to about 10 phr of liquid conjugated diene-based polymer having a weight average molecular weight of less than 80,000 provided however, where the particulate filler is exclusively rubber reinforcing carbon black, the partial composition contains at least 1 phr of liquid diene-based polymer.

The liquid conjugated diene-based liquid polymer may be, for example, a liquid cis 1,4-polyisoprene polymer and/or liquid cis 1,4-polybutadiene polymer. It is to be appreciated that such liquid polymers for the butyl rubber precursor composition are therefore polymers that contain olefinic unsaturation and therefore are not intended to include polyisobutylene that does not contain olefinic unsaturation. A commercial liquid cis 1,4-polyisoprene polymer may be, for example, LIR 50™ from the Kuraray Company of Osaki, Japan. A liquid cis 1,4-polybutadiene polymer (absorbed on a particulate filler) may be, for example, Karasol PS-01™ from the Drobny Polymer Association.

It is considered herein that the liquid polyisoprene polymer in the butyl rubber acts to aid in regulating the storage modulus G′ of the partially depolymerized butyl rubber. For example, addition of the liquid polyisoprene polymer has been observed to provide the partially depolymerized butyl rubber composition with a somewhat increased loss modulus G′ which may be desirable for some applications.

In one example, the uncured butyl based composition can include 100 parts of a butyl rubber copolymer, about 10 to 40 parts of carbon black, about 5 to 35 parts of polyisobutylene, about 5 to 35 parts of an oil extender, about 0 to 1 part of sulfur, and from about 1 to 15 parts of a peroxide vulcanizing agent.

The polyurethane compositions for use in the resulting sealant layer 22 (and precursor sealant layer 23) may further include one or more of the additional components as discussed above, such as reinforcing filler, e.g., carbon black, silica, coal dust, fibers, microspheres, processing oil, etc. It should be understood by one having ordinary skill in the art that additional components may be included in the sealant layer 22 as desired, such as antidegradants, accelerators, etc., in conventional amounts.

The resulting built-in sealant layer 22 (and precursor sealant layer 23) may further include a colorant to provide a non-black colored built-in sealant layer having the capability of visibly identifying a puncture wound. That puncture wound may extend through a black colored rubber inner liner layer, black colored rubber tire tread, and/or black colored sidewall layer to the built-in sealant layer by a physical flow of a portion of the non-black colored built-in sealant layer through the puncture wound to form a contrastingly non-black colored sealant on a visible surface of the black colored inner liner, tread, or sidewall.

The colorant may include titanium dioxide. For example, the colorant of the sealant layer 22 may be titanium dioxide where a white colored sealant layer is desired. Also, such colorant may include titanium dioxide as a color brightener together with at least one non-black organic pigment and/or non-black inorganic pigment or dye. Various colorants may be used to provide a non-black color to the sealant layer 22. Representative of such colorants are, for example, yellow colored colorants as Diarylide Yellow™ pigment from PolyOne Corporation and Akrosperse E-6837™ yellow EPMB pigment masterbatch with an EPR (ethylene/propylene rubber) from the Akrochem Company.

The various components of the precursor sealant layer 23, prior to building the tire 10, can be mixed together using conventional rubber mixing equipment, particularly an internal rubber mixer. The butyl rubber and polyurethane composition used in the sealant layer 22 generally has sufficient viscosity and enough unvulcanized tack to enable its incorporation into an unvulcanized tire without substantially departing from standard tire building techniques and without the use of complicated, expensive tire building equipment.

Material permitting, the precursor sealant layer 23, prior to building of the tire 10, may be formed into sheet stock that can be cut into strips and then positioned on a tire building apparatus 30, such as a tire drum, during the tire build-up process. The tire building process is described in detail further below.

The rubber tire inner liner 20 may be any known rubber inner liner for use in pneumatic tires 10. In one example, the rubber inner liner 20 can be a sulfur curative-containing halobutyl rubber composition of a halobutyl rubber such as for example chlorobutyl rubber or bromobutyl rubber. Such halobutyl rubber based inner liner layer may also contain one or more sulfur curable diene-based elastomers such as, for example, cis 1,4-polyisoprene natural rubber, cis 1,4-polybutadiene rubber and styrene/butadiene rubber, or mixtures thereof. The inner liner 20 is normally prepared by conventional calendering or milling techniques to form a strip of uncured compounded rubber of appropriate width. When the tire 10 is cured, the inner liner 20 becomes an integral, co-cured, part of the tire 10. Tire inner liners and their methods of preparation are well known to those having skill in such art.

The tire carcass 16 generally may be any conventional tire carcass for use in pneumatic tires 10. Generally, the tire carcass 16 includes one or more layers of plies and/or cords to act as a supporting structure for the tread portion 14 and sidewalls 12. The remainder of the tire components, e.g., tire tread 14, sidewalls 12, and reinforcing beads 18, also generally may be selected from those conventionally known in the art. Like the tire inner liner 20, the tire carcass 16, tire tread 14, and beads 18 and their methods of preparation are well known to those having skill in such art.

The pneumatic tire of FIG. 1 may be prepared, as best shown in FIG. 2, by building sealant layer 22 into an uncured tire 10a using tire drum 30 and conventional tire building techniques. More specifically, the innermost removable barrier layer 24, e.g., nylon, is first situated or positioned on the tire drum 30, with the remainder of the uncured tire 10a being subsequently built thereon. Generally, the barrier layer 24 is wrapped around the drum 30 so that one end of the barrier layer 24 slightly overlaps the other end to define pull tab 33 to allow for easy removal of the barrier layer 24 after tire cure, as shown in FIG. 3.

With further reference to FIG. 2, the precursor sealant layer 23 is positioned directly on the removable barrier layer 24. For example, the butyl rubber based composition or polyurethane composition can be formed into a strip or layer of unvulcanized rubber, by using conventional equipment such as a calendar, extruder, or any combination thereof. The thickness of the strip can vary in the unvulcanized tire. Generally, the thickness may range from about 0.13 cm (0.05 inches) to about 1.9 cm (0.75 inches). In passenger tires, the precursor sealant layer 23 may have a thickness of about 0.33 cm (0.125 inches) whereas for truck tires, the precursor sealant layer 23 may have a thickness of about 0.76 cm (0.3 inches). The built-in sealant layer 22 is generally situated in the crown region of the tire 10, and may include colorant so that it is of a non-black color that may contrast with the black colored inner liner, tread, or sidewall so that a tire puncture can be noticed.

The rubber inner liner 20 is then positioned on the precursor sealant layer 23, which is followed by the tire carcass 16. Finally, the rubber tire tread 14 is positioned on the tire carcass 16 thereby defining unvulcanized tire assembly 10a.

After the unvulcanized pneumatic tire 10a is assembled, the tire 10a is shaped and cured using a normal tire cure cycle. After curing, the composition of the precursor sealant layer 23 is gel-like and tacky which provides the pneumatic tire 10 with self-sealing properties and defines the built-in sealant layer 22.

Generally, the tire 10a can be cured over a wide temperature range. For example, passenger tires might be cured at a temperature ranging from about 130° C. to about 170° C. and truck tires might be cured at a temperature ranging from about 150° C. to about 180° C. Thus, a cure temperature may range, for example, from about 130° C. to about 180° C. and for a desired period of time. In one example, the tire assembly 10a is cured in a suitable mold at a temperature in a range of from about 150° C. to about 175° C. for a sufficient period of time such as to partially depolymerize the butyl rubber or thermally degrade non-flowing polyurethane that is neither gel-like nor substantially tacky, for example, thereby forming the built-in sealant layer 22 which has puncture sealing properties.

After curing, the removable barrier layer 24 is attached to the built-in sealant 22. Such barrier layer 24 can be removed from the pneumatic tire 10 to expose the sealant layer 22 to allow for sealing of resulting punctures that the tire 10 may encounter. In one example, as shown in FIG. 3, the barrier layer 24 may be removed by grabbing the pull-tab 33 then pulling to remove from the sealant layer 22. The barrier layer 24, which is substantially inextensible at ambient temperature, is removable without tearing into pieces.

Non-limiting examples of test pieces of the pneumatic tire 10 with built-in sealant 22 in accordance with the detailed description are now disclosed below. These examples are merely for the purpose of illustration and are not to be regarded as limiting the scope of the invention or the manner in which it can be practiced. Other examples will be appreciated by a person having ordinary skill in the art.

Three pneumatic tire test pieces were prepared for testing. Each test piece is described below.

Test Piece No. 1

The following layers were assembled one on top of the other:
7″×7″ calendared tread of thickness 0.1″
4″×4″ wire of thickness 0.068″
7″×7″ belt (aligned with the wire) of thickness 0.026″
7″×7″ inner liner compound of thickness 0.03″
4″×4″ butyl based precursor sealant layer of thickness 0.25″ undrawn Dartek™ C917 thermoformable nylon film of thickness 2 mil The above laminated test piece was cured for 35 minutes at 150° C. and 200 psi. The thermoformable nylon film was left in place after cure.

Test Piece No. 2

The following layers were assembled one on top of the other:

7″×7″ calendared tread of thickness 0.1″
4″×4″ wire of thickness 0.068″
7″×7″ belt (aligned with the wire) of thickness 0.026″
7″×7″ inner liner compound of thickness 0.03″
4″×4″ butyl based precursor sealant layer of thickness 0.25″ undrawn Dartek™ C917 thermoformable nylon film of thickness 2 mil The above laminated test piece was cured for 35 minutes at 150° C. and 200 psi. The thermoformable nylon film was removed after cure.

Control Test Piece

The following layers were assembled one on top of the other:
6″×6″ calendared tread of thickness 0.1″
4″×4″ wire of thickness 0.068″
6″×6″ belt (aligned with the wire) of thickness 0.026″
4″×4″ butyl based precursor sealant layer of thickness 0.25″
7″×7″ inner liner compound of thickness 0.03″ The above laminated test piece was cured for 35 minutes at 150° C. and 200 psi.

Concerning test piece nos. 1 and 2, the Dartek™ films were obtained from DuPont of Ontario, Canada. The butyl based composition used for the sealant layer in test piece nos. 1 and 2, and in the control is set forth below in Table I. The composition was prepared in a two-step process with the butyl rubber and the specified ingredients being mixed in a first non-productive step. In a second step, peroxide was mixed into the butyl rubber mixture.

TABLE I
Composition of Butyl Based Sealant

| Component | Stage | Amount (phr) |
|---|---|---|
| Butyl rubber | Non-productive 1 (NP1) | 100.00 |
| Medium processing oil | NP1 | 3.00 |
| Silica | NP1 | 20.00 |
| Clay | NP1 | 10.00 |
| Titanium dioxide | NP1 | 2.0 |
| Dusting agent | NP1 | 0.5 |
| Yellow pigment¹ | NP1 | 1.00 |
| NP1 | Productive | 136.5 |
| Peroxide² (40%) | Productive | 12.00 |
| Total | | 148.50 |

¹Yellow pigment, Akrochem E-6837
²Link-Cup ® NBV40C available from GEO Specialty Chemicals of Gibbstown, NJ; chemical name: n-butyl-4,4-di(tert-butylperoxy)valerate, 40% supported on calcium carbonate

The cured test pieces were tested to evaluate puncture sealing effectiveness. In the testing process, each test piece was secured lengthwise across an open chamber of a box, which defined a benchtop nail hole tester, to generally seal the opening to the chamber. Test piece nos. 1 and 2 were situated so that the innermost removable barrier layer faced the open chamber and the tire tread faced outwardly. The control was situated so that the inner liner faced the open chamber and the tire tread faced outwardly. In the chamber, air pressure could be established via an inlet valve, maintained, and monitored to simulate a pressurized pneumatic tire. A nail was used to manually puncture the test piece. Each test piece was subjected to puncturing by nails of varying and increasing diameter to evaluate air pressure loss after nail insertion, removal, and reinflation (if needed). Air pressure readings at each step were taken after a two-minute period. The results of the puncture sealing testing are set out in Table II below.

TABLE II
Test Results

| | 1 | 2 | Control |
|---|---|---|---|
| Initial psi = 35 | 35 | 35 | 35 |
| After 0.136″ | | | |
| diameter nail | | | |
| insertion | | | |
| After nail | 24 | 17 | 15 |
| removal | | | |
| Re-inflation to | 0 | 35 | 35 |
| 35 psi | | | |
| Initial psi = 35 | 35 | 35 | 35 |
| After 0.0165″ | | | |
| diameter nail | | | |
| insertion | | | |
| After nail | 0 | 8 | 8 |
| removal | | | |
| Re-inflation to | 0 | 35 | 35 |
| 35 psi | | | |

Based upon the test results, the puncture sealing properties of test piece no. 2 is at least as good as the control. Specifically, the test results showed that test piece no. 2 and the control could seal nail holes by maintaining air pressure after reinflation after being punctured by a nail 0.136″ and 0.165″ in diameter. In contrast, test piece no. 1 could not maintain air pressure after reinflation after being punctured by the nail 0.136″ in diameter. In addition, test piece no. 1 could not seal during reinflation because the sealant layer could not flow into the puncture in the presence of the non-removed thermoformable film.

Test piece no. 2 and the control were also placed in an oven at 150° C. for 15 minutes to test for blister formation. Each test piece was then removed from the oven and visually observed. Blister formation was not detected in test piece no. 2. However, the control showed heavy blister formation in the innermost inner liner. This suggested that volatile material formed from thermal degradation of the butyl rubber based sealant could not escape through the inner liner in the control but was unhindered in test piece no. 2 due to the removal of the thermoformable film.

Accordingly, there is provided a pneumatic tire 10 that has an ability to seal against various puncturing objects and can eliminate or reduce inner liner blister formation in the tire 10.

While the present invention has been illustrated by the description of one or more embodiments thereof, and while the embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative product and method and illustrative examples shown and described. Accordingly, departures may be made from such details without departing from the scope of the general inventive concept.

What is claimed is:

1. a method of preparing a pneumatic tire comprising:
positioning a removable barrier layer on a tire-building apparatus;
positioning a precursor sealant layer directly on the removable barrier layer;
forming an unvulcanized tire assembly on the sealant layer; and
vulcanizing the unvulcanized tire assembly under conditions of heat and pressure such that the precursor sealant layer provides the pneumatic tire with a built-in sealant layer with self-sealing properties.

2. The method of claim 1 further comprising removing the removable barrier layer from the pneumatic tire to expose the built-in sealant layer.

3. The method of claim 2 wherein the removable barrier layer includes an end defining a pull-tab such that removing the removable barrier comprises pulling the pull-tab to remove the removable barrier layer from the pneumatic tire to expose the built-in sealant layer.

4. The method of claim 1 wherein the removable barrier layer defines a thermoformable film of polymeric material.

5. The method of claim 1 wherein the removable barrier layer defines a thermoformable film of nylon or a blend of nylon and rubber.

6. The method of claim 1 wherein the precursor sealant layer comprises an uncured butyl rubber-based rubber composition.

7. The method of claim 1 wherein the sealant layer comprises a polyurethane based composition.

8. A pneumatic tire prepared according to the method of claim 1.

9. A method of preparing a pneumatic tire comprising:
positioning a thermoformable film of polymeric material on a tire-building apparatus;
positioning a precursor sealant layer directly on the thermoformable film, the precursor sealant layer comprising an uncured butyl rubber-based rubber composition or a polyurethane based composition; and
positioning a rubber inner liner directly on the barrier layer followed by a tire carcass then a rubber tire tread on the tire carcass to define an unvulcanized tire assembly, wherein the precursor sealant layer provides the pneumatic tire with a built-in sealant layer with self-sealing properties after vulcanization.

10. The method of claim 9 wherein the removable barrier layer defines a thermoformable film of nylon or a blend of nylon and rubber.

11. The method of claim 9 further including vulcanizing the unvulcanized tire assembly under conditions of heat and pressure such that the precursor sealant layer provides the pneumatic tire with the built-in sealant layer with self-sealing properties.

12. The method of claim 11 further including removing the removable barrier layer from the pneumatic tire to expose the built-in sealant layer.

13. The method of claim 12 wherein the removable barrier layer includes an end defining a pull-tab such that removing the removable barrier comprises pulling the pull-tab to remove the removable barrier layer from the pneumatic tire to expose the built-in sealant layer.

14. A pneumatic tire prepared according to the method of claim 9.

15. A pneumatic tire with built-in sealant layer comprising:
an outer circumferential rubber tread, a supporting carcass therefor, a rubber inner liner disposed inwardly from the supporting carcass, an innermost removable barrier layer, and a built-in sealant layer adjacent the innermost barrier layer and disposed inwardly from the rubber inner liner, wherein the sealant layer provides self-sealing properties to the pneumatic tire.

16. The tire of claim 15 wherein the removable barrier layer defines a thermoformable film of polymeric material.

17. The tire of claim 15 wherein the removable barrier layer defines a thermoformable film of nylon or a blend of nylon and rubber.

18. The tire of claim 15 wherein the sealant layer comprises a butyl rubber-based rubber composition.

19. The tire of claim 15 wherein the sealant layer comprises a polyurethane based composition.

20. The tire of claim 15 wherein the inner liner is positioned directly on the sealant layer.
